(19) United States
(12) Patent Application Publication
(10) Pub. No.: US 2020/0101886 A1
(43) Pub. Date: Apr. 2, 2020

(54) CUP HOLDER

(71) Applicant: TOYODA GOSEI CO., LTD., Kiyosu-shi (JP)

(72) Inventors: Minoru SHIBATA, Kiyosu-shi (JP); Yuhki ICHIKAWA, Kiyosu-shi (JP); Akira AZUMI, Kiyosu-shi (JP); Kenji ASANO, Nagoya-shi (JP)

(21) Appl. No.: 16/554,704

(22) Filed: Aug. 29, 2019

(30) Foreign Application Priority Data
Sep. 28, 2018 (JP) 2018-184876

(51) Int. Cl. B60N 3/10; H02J 7/02

(52) U.S. Cl. CPC B60N 3/105; H02J 7/025

(57) ABSTRACT

A cup holder includes a main body and a lid. The main body has a tubular structure with a closed end. The lid is configured to selectively open and close an upper opening of the main body. The main body has an accommodation region configured to accommodate a cup. The lid includes a power transmitter coil configured to transmit AC power to a power receiving device having a power receiver coil.

### BACKGROUND

### 1. Field

The present disclosure relates to a cup holder capable of wirelessly charging a power receiving device.

### 2. Description of Related Art

International Publication No. 2011/035191 discloses a wireless charger.

FIG. 12 discloses a conventional vehicle cup holder 60, which functions as a wireless charger. The cup holder 60 incorporates a deflection plate 61, which serves as a transmission antenna. The cup holder 60 is configured such that when a portable electronic device 62 (power receiving device) is inserted in the cup holder 60, the portable electronic device 62 and the deflection plate 61 contact each other while being parallel with each other. In this state, coupled-mode resonance is caused between the deflection plate 61 and a reception antenna 63 of the portable electronic device 62 to wirelessly charge the portable electronic device 62.

Since the wireless charger of the above-described document has the deflection plate 61 arranged in the cup holder 60, a cup may contact the deflection plate 61 when inserted into the cup holder 60. The deflection plate 61 acts as an obstacle and may reduce the usability of the cup holder 60.

### SUMMARY

It is an objective of the present disclosure to provide a cup holder that has a power transmitting function and prevents usability from being reduced when a cup is inserted.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a cup holder is provided that includes a main body having a tubular structure with a closed end, and a lid configured to selectively open and close an upper opening of the main body. The main body has an accommodation region configured to accommodate a cup. The lid includes a power transmitter coil configured to transmit AC power to a power receiving device having a power receiver coil.

Other features and aspects will be apparent from the following detailed description, the drawings, and the claims.

### BRIEF DESCRIPTION OF THE DRAWINGS

FIG. 1 is a perspective view of a cup holder.

FIG. 2 is a perspective view of the cup holder with the upper opening opened.

FIG. 3 is a plan view of the cup holder with the upper opening opened.

FIG. 4 is an end view taken along line 4-4 of FIG. 3.

FIG. 5 is a diagram illustrating a lid opening-closing mechanism.

FIG. 6 is a diagram illustrating the lid opening-closing mechanism.

FIG. 7 is a diagram illustrating the lid opening-closing mechanism.

FIG. 8 is a perspective view of the cup holder with a power receiving device placed therein.

FIG. 9 is a diagram illustrating a lid opening-closing mechanism of a cup holder according to a modification.

FIG. 10 is an end view of a cup holder according to another modification.

FIG. 11 is a perspective view of a cup holder according to another modification.

FIG. 12 is a perspective view of a prior art cup holder.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

A cup holder 10 according to an embodiment will be described.

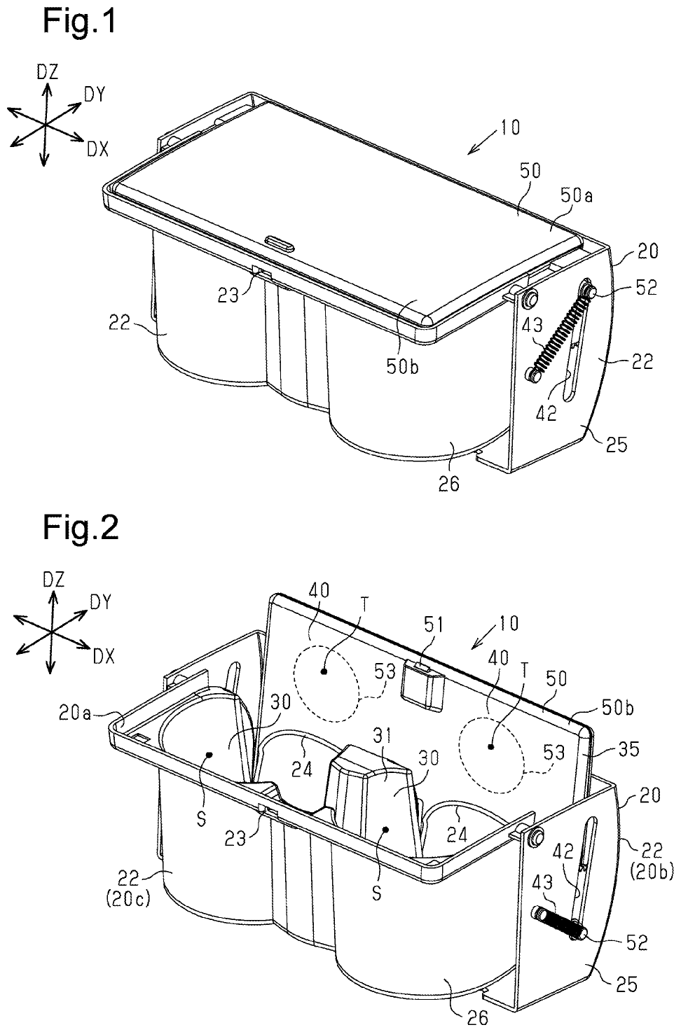

As shown in FIGS. 1 and 2, the cup holder 10 includes a main body 20 and a lid 50. The main body 20 has a tubular structure with a closed end. The lid 50 is configured to selectively open and close an upper opening 20a of the main body 20. The main body 20 has two first regions 30 and two second regions 40. Each first region 30 functions as an accommodation region for accommodating a cup. Each second region 40 functions as an accommodation region for accommodating a power receiving device. The lid 50 has a first end 50a, which is connected to the main body 20, and a second end 50b located on the opposite side to the first end 50a. The lid 50 is configured to be pivotal relative to the main body 20 with the first end 50a serving as a pivot.

When the upper opening 20a of the main body 20 is open as shown in FIGS. 2 and 4, the first end 50a of the lid 50 is accommodated in the accommodation region of the main body 20, and the second end 50b of the lid 50 protrudes upward from the upper opening 20a of the main body 20. That is, the main body 20 has a third region 35, which serves as an accommodation region for accommodating the first end 50a of the lid 50. The cup holder 10 is configured such that, with the upper opening 20a opened, a cup 11 and a power receiving device 12 can be accommodated in the main body 20 simultaneously. The cup holder 10 is capable of accommodating two cups 11 side by side. The cup holder 10 is also capable of accommodating two power receiving devices 12 side by side. The cup 11, the power receiving device 12, and the lid 50 are arranged in order as shown in FIG. 4.

The direction in which accommodated cups 11 are arranged is defined as a width direction DX. The direction in which a cup 11, a power receiving device 12, and the lid 50 are arranged is defined as a front-rear direction DY. The up-down direction of the cup holder 10 is defined as a vertical direction DZ.

Cups 11 that can be accommodated in the accommodation region of the main body 20 are not particularly limited, and may be containers such as cans, glass bottles, plastic bottles, cartons, and paper cups. The power receiving device 12 accommodated in the main body 20 is not particularly limited, and may be any device capable of receiving AC power transmitted from a power transmitter coil, which will be discussed below. The power receiving device 12 is, for example, a mobile device such as a mobile phone. The cup holder 10 is arranged, for example, in the console box or the instrument panel of a vehicle.

The main body 20 will now be described.

As shown in FIGS. 2 to 4, the main body 20 includes a bottom wall 21 and side walls 22, which extend upward from the periphery of the bottom wall 21. The upper ends of the side walls 22 form the upper opening 20a. The upper opening 20a has a substantially rectangular shape having a longer dimension in the width direction DX than in the front-rear direction DY. When the upper opening 20a is open, the lid 50 is accommodated in the third region 35, which is located in the vicinity of a first end 20b in the front-rear direction DY of the main body 20. One of the side walls 22 of the main body 20 constitutes a second end 20c in the front-rear direction DY of the main body 20, and an engaging portion 23 is provided at the top of that side wall 22. The engaging portion 23 is engaged with an engagement portion 51 of the lid 50, which will be discussed below, to restrict pivoting motion of the lid 50.

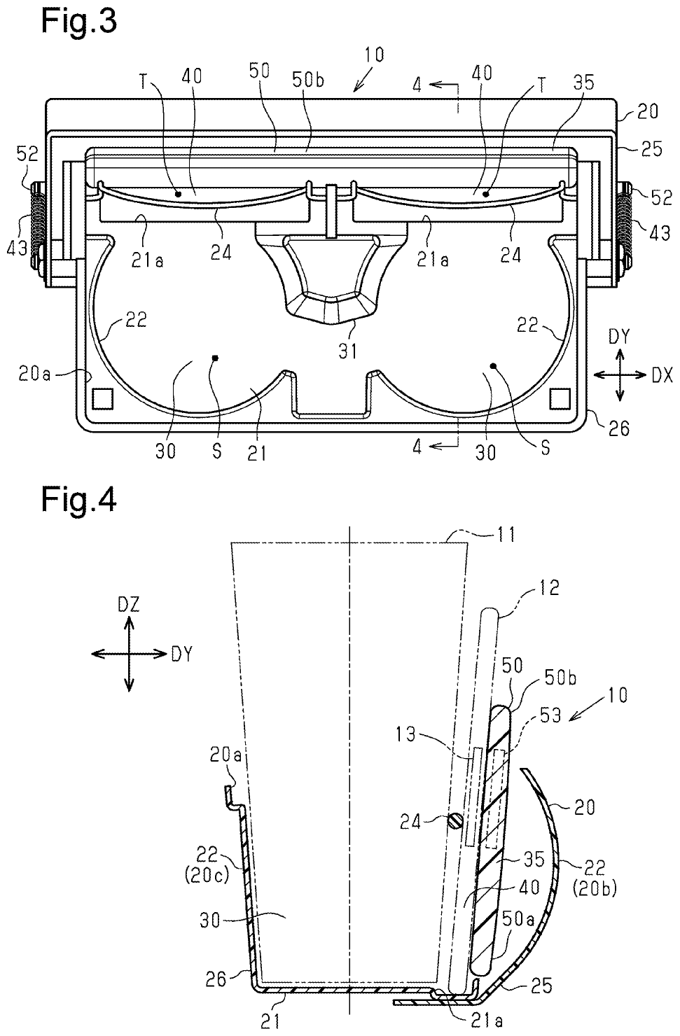

As shown in FIGS. 3 and 4, the two first regions 30 for accommodating cups 11 are arranged in the width direction DX. A partition wall 31 is provided between the two first regions 30 to separate the first regions 30 from each other. In a cross section of the main body 20, the inner periphery of the side walls 22 constituting each first region 30 and the inner periphery of the partition wall 31 are configured to be substantially on the same circle. The first regions 30 thus each have a columnar space S. Since the first regions 30 each have a columnar space S, cups 11 are held easily.

As shown in FIGS. 2 to 4, the second regions 40 for accommodating power receiving devices 12 are located at positions that are closer to the first end 20b of the main body 20 than the first regions 30 and closer to the second end 20c of the main body 20 than the third region 35. That is, the second regions 40 are located between the first regions 30 and the third region 35 in the front-rear direction DY. Each second region 40 has a plate-shaped space T adjacent to the lid 50 accommodated in the third region 35. The two second regions 40 are arranged side by side in the width direction DX.

As shown in FIG. 3, the bottom wall 21 of the main body 20 has recesses 21a conforming to the shapes of the second regions 40. The recesses 21a limit displacement of the power receiving devices 12 accommodated in the second regions 40.

As shown in FIGS. 2 to 4, an urging member 24 for urging the power receiving device 12 toward the lid 50 is arranged in each second region 40. The urging member 24 is formed by a wire bent into a curved shape. The power receiving device 12 is held between the urging member 24 and the lid 50 so that the power receiving device 12 is urged toward the lid 50. Urging the power receiving device 12 with the urging member 24 allows the power receiving device 12 to be arranged at a predetermined position in the second region 40.

The main body 20 of the cup holder 10 is separable at the middle in the front-rear direction DY. That is, as shown in FIGS. 2 and 4, the main body 20 is formed by connecting a first member 25, which includes the first end 20b in the front-rear direction DY, and a second member 26, which includes the second end 20c in the front-rear direction DY.

The lid 50 will now be described.

As shown in FIGS. 1 and 2, the lid 50 is formed to have a rectangular plate shape. Pivots 52 are attached to the first end 50a of the lid 50. The pivots 52 connect the lid 50 to the main body 20 of the cup holder 10. The pivots 52 allow the lid 50 to be pivotal relative to the main body 20. The engagement portion 51, which engages with the engaging portion 23 of the main body 20, is provided at the second end 50b of the lid 50.

When the upper opening 20a of the main body 20 is open as shown in FIG. 4, the lid 50 is accommodated in the third region 35 of the main body 20 while being upright with respect to the main body 20. Specifically, the lid 50 is accommodated in the third region 35 while being inclined with respect to the vertical direction DZ, such that the first end 50a of the lid 50 is at the lower end and that the lid 50 is progressively spaced away from the first regions 30 in the front-rear direction DY toward the second end 50b. When accommodated in the third region 35, the inclination angle of the lid 50 with respect to the vertical direction DZ can be 0 to 20 degrees. When accommodated in the third region 35, the second end 50b of the lid 50 protrudes from the upper opening 20a.

As shown in FIGS. 2 and 4, the lid 50 incorporates two power transmitter coils 53 capable of transmitting AC power to power receiving devices 12. The two power transmitter coils 53 are arranged side by side in the width direction DX. The power transmitter coils 53 are arranged at positions that overlap with power receiver coils 13 of the power receiving devices 12 when the power receiving devices 12 are put against the lid 50. The cup holder 10 is configured such that the power receiving devices 12 are charged wirelessly when the power receiver coils 13 overlap with the power transmitter coils 53. The power receiver coil 13 overlapping with the power transmitter coil 53 refers to a state in which the power receiver coil 13 and the power transmitter coil 53 overlap with each other when viewed in the thickness direction of the power receiving device 12 and the lid 50. The state in which the power receiver coil 13 and the power transmitter coil 53 overlap with each other is not limited to the state in which the power receiver coil 13 and the power transmitter coil 53 overlap completely, but also includes a state in which these are slightly offset from each other within the range allowing for wireless charging.

The method of wireless charging is not particularly limited, but may be any known method of wireless charging. Known methods of wireless charging include the electromagnetic induction method, the radio wave receiving method, and the resonance method. As the electromagnetic induction method, an international standard called Qi may be employed.

The pivoting mechanism of the lid 50 will now be described.

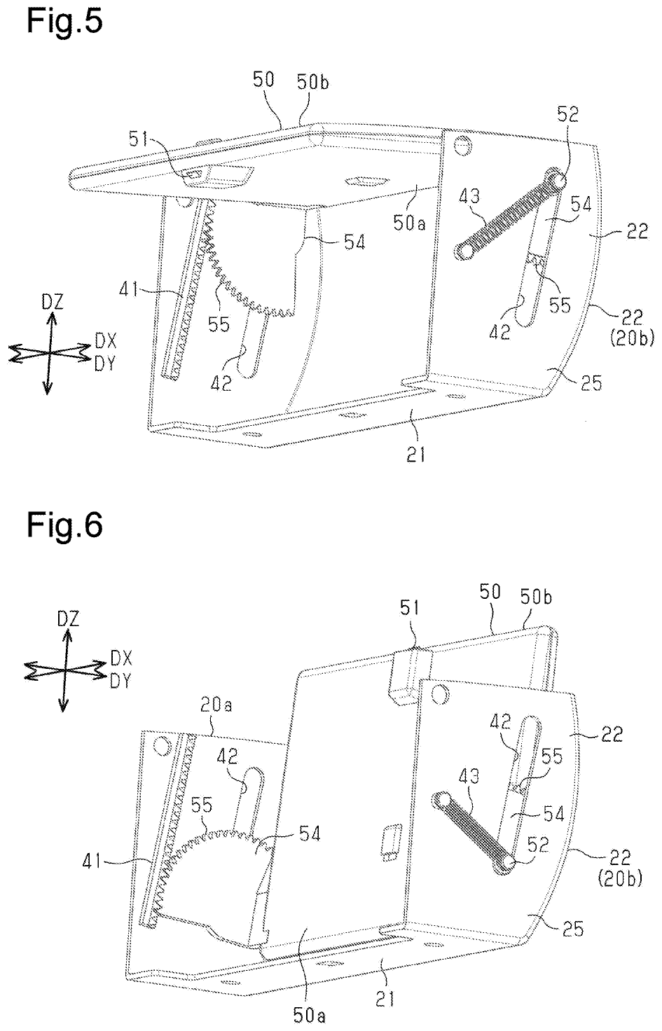

As shown in FIG. 5, the lid 50 has pinion gears 54 at the opposite ends in the width direction DX. The pinion gear 54 has a sectoral shape having a central angle of 90 degrees and has gear teeth 55 arranged on the arcuate portion. The pinion gear 54 is arranged in the vicinity of the first end 50a of the lid 50 such that the arcuate portion faces the second end 50b of the lid 50. The pinion gear 54 has a columnar pivot 52, which protrudes outward in the width direction DX of the lid 50. The lid 50 is configured to pivot about the pivots 52.

As shown in FIG. 5, the first member 25, which is a member including the first end 20b of the main body 20, has a pair of side walls 22 opposed each other in the width direction DX. Each side wall 22 of the first member 25 has a rack 41 that extends straight on the inner side. Specifically, the rack 41 is slightly inclined with respect to the vertical direction DZ such that the rack 41 approaches the first end 20b of the main body 20 toward the upper end. A cutout 42, which has the same inclination angle as the rack 41, is formed between the rack 41 and the first end 20b of the main body 20. Each side wall 22 of the first member 25 has a coil spring 43 on the outer side. One end of the coil spring 43 is connected to the outer surface of the side wall 22.

The lid 50 is attached to the first member 25 of the main body 20 with the racks 41 meshed with the pinion gears 54 of the lid 50 as shown in FIG. 5. The pivot 52 of the pinion gear 54 is passed through the cutout 42 of the first member 25 from inside, and is connected to the other end of the coil spring 43 outside the side wall 22 of the first member 25.

When the upper opening 20a is closed as shown in FIG. 5, the engagement portion 51 of the lid 50 is engaged with the engaging portion 23 of the main body 20. In this state, the lid 50 receives force acting to pivot the pivots 52 of the lid 50 by the contractile force of the coil springs 43.

When the engagement portion 51 of the lid 50 is disengaged, the lid 50 pivots about the pivots 52 by the contractile force of the coil springs 43 as shown in FIG. 6. As the pinion gears 54 move along the racks 41, the first end 50a of the lid 50 is accommodated in the first member 25. This opens the upper opening 20a of the main body 20. The cup holder 10 may be configured such that the pivoting speed of the lid 50 is reduced immediately before the upper opening 20a of the main body 20 is completely opened by causing the contractile force of the coil springs 43 to act on the pivots 52 of the pinion gears 54 immediately before the upper opening 20a is completely opened.

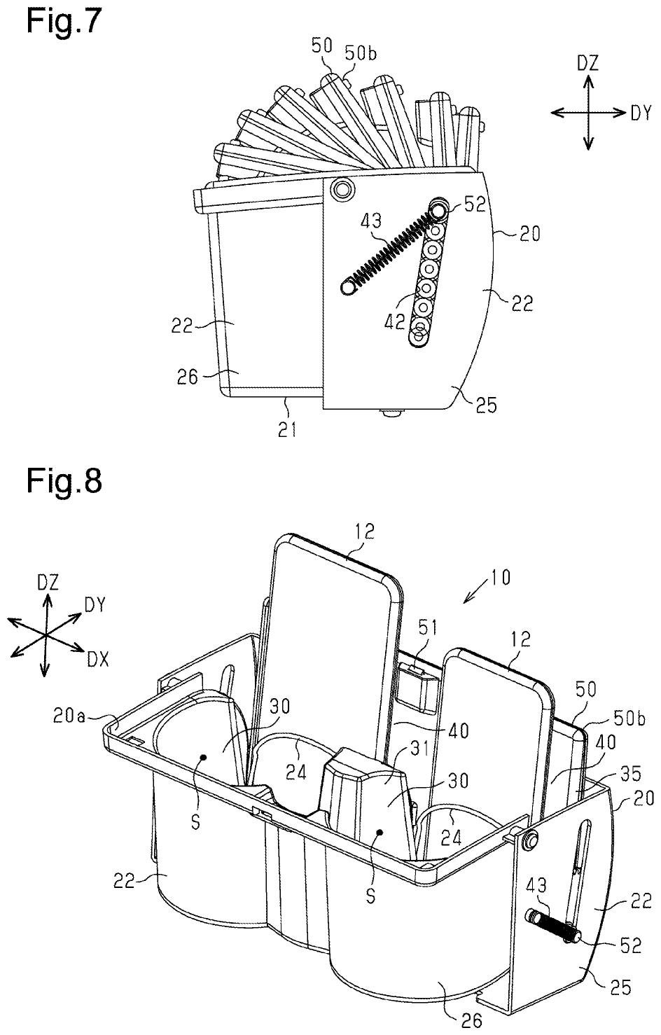

As the lid 50 pivots, the first end 50a of the lid 50 is accommodated in the first member 25 as shown in FIG. 7. This reduces the projecting amount of the second end 50b of the lid 50 from the upper opening 20a. Thus, as compared to a configuration in which, for example, the first end 50a of the lid 50 is pivotally connected to the main body 20 via hinges, the projecting amount of the second end 50b of the lid 50 after pivoting is small.

The operation of the present embodiment will now be described.

When the upper opening 20a is open as shown in FIG. 8, the lid 50 is accommodated in the third region 35 of the main body 20 while being upright with respect to the main body 20. The main body 20 has in it the first regions 30, which are configured to accommodate cups 11, and the second regions 40, which are configured to accommodate power receiving devices 12. The second regions 40 are adjacent to the lid 50. Thus, if a power receiving device 12 is put against the lid 50, the power receiving device 12 is accommodated in the second region 40 while being parallel with the lid 50. Also, a cup 11 can be accommodated in the first region 30 with a power receiving device 12 accommodated in the second region 40.

The present embodiment has the following advantages.

(1) The main body 20 has the first regions 30 configured to accommodate cups 11. The lid 50 has power transmitter coils 53 configured to transmit AC power to the power receiving devices 12, which include power receiver coils 13. Since the lid 50 of the cup holder 10 is used as a component in which the power transmitter coils 53 are installed, the lid 50 is made multifunctional. Since no obstacles are arranged in the first regions 30, in which cups 11 are accommodated, the usability of the cup holder 10 is not reduced even though the cup holder 10 has a power transmitting function.

(2) The power transmitter coils 53 are configured to transmit AC power to the power receiving devices 12 accommodated in the second regions 40. That is, when the power receiving devices 12 are accommodated in the second regions 40, the power transmitter coils 53 transmit AC power to the power receiving devices 12. Since the power receiving devices 12 are charged wirelessly while being accommodated in the second regions 40, the wireless charging is performed in a stable manner.

(3) The accommodation regions include the first regions 30, which are configured to accommodate cups 11, and the second regions 40, which are configured to accommodate power receiving devices 12. Since cups 11 and power receiving devices 12 can be accommodated in the accommodation regions of the cup holder 10 simultaneously, the usability of the cup holder 10 is improved.

(4) When the upper opening 20a is open, the lid 50 is upright with respect to the main body 20. When a power receiving device 12 is put against the lid 50, which is upright with respect to the main body 20, the power transmitter coil 53 of the lid 50 transmits AC power to the power receiving device 12. Since wireless charging can be performed simply by putting the power receiving device 12 against the lid 50, the wireless charging can be performed easily. Since the surface of the upright lid 50 is used as a placement surface for the power receiving device 12, a sufficient length of the second region 40 in the vertical direction DZ is easily ensured. Thus, even if a power receiving device 12 is placed vertically, the power receiver coil 13 and the power transmitter coil 53 are easily overlapped with each other while arranging the power receiving device 12 to be parallel with the lid 50. This improves the charging efficiency of the wireless charging by effectively utilizing the space in the cup holder 10.

(5) Part of the lid 50 is accommodated in the third region 35 of the main body 20 with the lid 50 being upright with respect to the main body 20. Thus, the projecting amount of the lid 50 is reduced by the amount of the part accommodated in the third region 35. This prevents the lid 50 from interfering with members that are not part of the cup holder 10. The limited space in the passenger compartment is thus utilized effectively.

The above-described embodiment may be modified as follows. The above-described embodiment and the following modifications can be combined as long as the combined modifications remain technically consistent with each other.

The main body 20 of the cup holder 10 does not need to be separable at the middle in the front-rear direction DY into the first member 25 and the second member 26, but may be formed integrally without being separable.

In the above-described embodiment, the first regions 30 and the second region 40 are separate regions, but the first regions 30 and the second regions 40 may be the same regions. That is, the main body 20 of the cup holder 10 may be configured such that cups 11 and power receiving devices 12 are accommodated in the same regions. If cups 11 and power receiving devices 12 are accommodated in the same regions, the size of the cup holder 10 will be allowed to be reduced.

A partition wall may be provided between the first regions 30 and the second regions 40 to define the first regions 30 and the second regions 40. For example, a partition wall may be provided between the first regions 30 and the second regions 40 so that, when the first regions 30 are wet with liquid, the liquid will not enter the second regions 40.

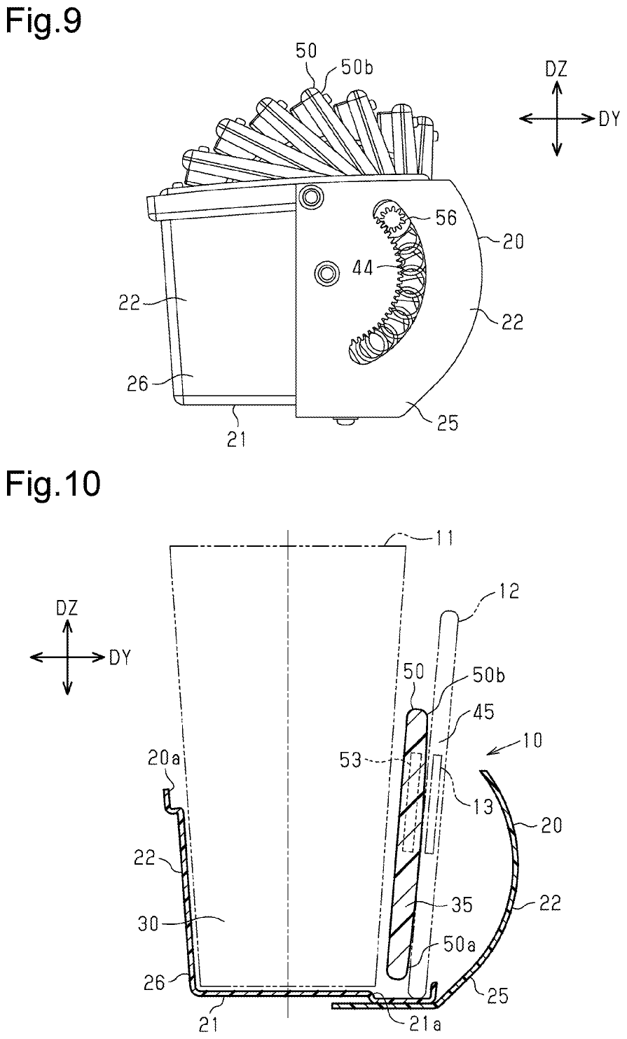

The pivoting mechanism of the lid 50 is not limited to that in the above-described embodiment. For example, as shown in FIG. 9, a circular pinion gear 56 may be provided at each of the opposite ends of the lid 50 in the width direction DX, and gear teeth 44 arranged on a curve may be provided on the side walls 22 of the first member 25 in the main body 20 of the cup holder 10. The lid 50 may be configured to be pivoted by meshing the circular pinion gears 56 with the gear teeth 44.

The position of the second regions is not limited to that in the above-described embodiment. For example, as shown in FIG. 10, second regions 45 for accommodating power receiving devices 12 may be provided between the pivoted and upright lid 50 and the first end 20b in the front-rear direction DY of the main body 20 of the cup holder 10. In this configuration, urging members for urging power receiving devices 12 toward the lid 50 may be provided as necessary. Further, second regions 40 and 45 for accommodating power receiving devices 12 may be provided on the front side and the rear side of the upright lid 50. That is, the cup holder 10 may be configured such that wireless charging is possible both on the front side and the rear side of the lid 50.

In the above-described embodiment, the power receiving device 12 is vertically arranged in the second region 40. However, the power receiving device 12 may be arranged horizontally.

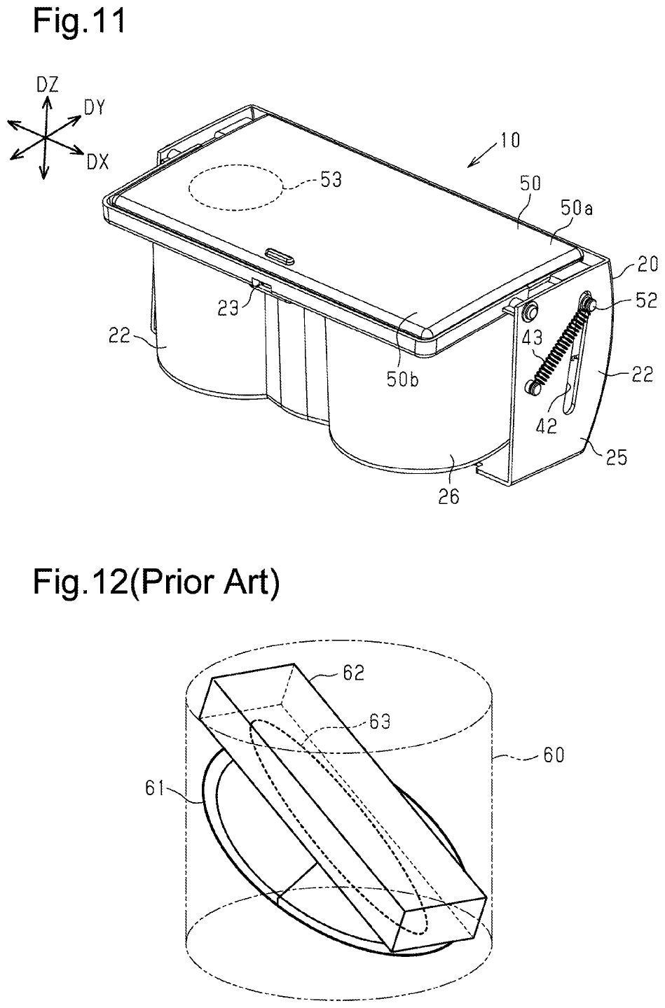

As shown in FIG. 11, the cup holder 10 may be configured such that, in a state in which the upper opening 20a in the main body 20 of the cup holder 10 is closed, a power receiving device 12 is placed on the front side of the lid 50 to perform wireless charging. In this configuration, a power transmitter coil 53 is provided to transmit power to the front side of the lid 50, and the cup holder 10 is configured to wirelessly charge the power receiving device 12 placed on the lid 50. Since wireless charging can be performed simply by placing a power receiving device 12 on the lid 50, the wireless charging can be performed easily. The cup holder 10 can be used in the same manner as an ordinary cup holder when the upper opening 20a is open. The usability of the cup holder 10 is prevented from being reduced.

The lid 50 may be entirely accommodated in the third region 35 of the main body 20 when the lid 50 is upright with respect to the main body 20. That is, the second end 50b of the lid 50 may be configured not to protrude from the upper opening 20a. Also, the lid 50 may be configured so as not to be accommodated in the third region 35 of the main body 20 even when the lid 50 is pivoted. For example, the first end 50a of the lid 50 may be connected to the main body 20 via a hinge, so that the lid 50 is not accommodated in the third region 35 of the main body 20 even when the lid 50 is pivoted.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A cup holder comprising:
a main body having a tubular structure with a closed end; and
a lid configured to selectively open and close an upper opening of the main body, wherein
the main body has an accommodation region configured to accommodate a cup, and
the lid includes a power transmitter coil configured to transmit AC power to a power receiving device having a power receiver coil.

2. The cup holder according to claim 1, wherein the power transmitter coil transmits AC power to the power receiving device when the power receiving device is accommodated in the accommodation region.

3. The cup holder according to claim 2, wherein the accommodation region includes
a first region configured to accommodate the cup, and
a second region configured to accommodate the power receiving device.

4. The cup holder according to claim 1, wherein
when the upper opening is open, the lid is upright with respect to the main body, and
the power transmitter coil transmits AC power to the power receiving device when the lid is upright with respect to the main body and the power receiving device is put against the lid.

5. The cup holder according to claim 4, wherein at least part of the lid is accommodated in the main body when the lid is upright with respect to the main body.
